(19) United States
(12) Patent Application Publication
(10) Pub. No.: US 2022/0327490 A1
(43) Pub. Date: Oct. 13, 2022

(54) SYSTEM OF AUTOMATED EMPLOYMENT MATCHING BASED ON POSITION AND PROSPECT PROFILES

(71) Applicants: Katherine B. Hutton, San Diego, CA (US); Ryan W. Volberg, Port Moody (CA)

(72) Inventors: Katherine B. Hutton, San Diego, CA (US); Ryan W. Volberg, Port Moody (CA)

(21) Appl. No.: 17/718,968

(22) Filed: Apr. 12, 2022

(30) Foreign Application Priority Data
Apr. 12, 2021 (CA) 3117014

(51) Int. Cl. G06Q 10/10

(52) U.S. Cl. CPC G06Q 10/1053

(57) ABSTRACT

A system and method for facilitating offering and filling of employment positions by employers, administered without employer intervention from the completion of job listing to the onboarding of a completed hire. Job candidates are matched by hiring criteria with available positions, and can accept an offered position through an electronic interface. Personality profiles of successful prior employees are used to increase match certainty and enhance employer confidence in the system.

### CROSS-REFERENCE TO RELATED APPLICATION(S)

This application is a Continuation-in-part application of U.S. patent application Ser. No. 17/230,881 filed on Apr. 14, 2021, which claims priority to Canadian Patent Application No. 3,111,524 filed on Mar. 8, 2021, the contents of all of which are herein incorporated by reference in their entireties.

### FIELD OF THE INVENTION

This invention is in the field of automated business systems and more particularly discloses an automated hiring system used to qualify and offer/select employees for job hiring without the need for employer intervention or participation in the hiring process.

### BACKGROUND

Many industries have benefitted from significant speed and quality enhancements in their business processes from the deployment of software based and machine learning systems in certain business functions. These systems allow for significantly improved outcomes and optimized workflows across virtually any aspect of a business.

One of the areas in which businesses invest a great deal of time and effort is in the hiring process—ensuring the hiring of compatible employees for different jobs in organizations can in many cases be a full-time function for a number of employees or entire departments in organizations, and if it were possible to provide enhanced tools for use in this business function it is believed that many businesses of all sizes could benefit.

The effort required to maintain a full employee roster is particularly difficult in companies having high turnover in certain job categories. For example, in the hospitality industry and other areas, some companies can have over 100% turnover in their employee roster on an annual basis—if it were possible to provide tools and systems to enhance the hiring outcomes for these companies, these tools would enjoy commercial acceptance and success.

One of the additional issues that is problematic in the context of hiring and exacerbated further roles such as those discussed where there is constant ongoing higher volume hiring taking place is that of bias. Removal of bias from hiring processes administered by human elements is an ongoing discussion point and issue. If it were possible to create a system that removed human elements of the hiring process it is anticipated that a substantial improvement if not a complete removal of bias from the hiring process could be achieved.

The need for different processes and approaches in hiring in different job categories, executive levels or the like makes it difficult to conceive of a tool having equal utility across all sectors. In this case, we are seeking to develop a tool to enhance hiring processes in the high-turnover, typically hourly, job categories—in many of these categories there is far less subjective consideration that goes into hiring, and job candidates can be selected by and large on the basis of availability, since much if not all of the training for the position is provided by the employer. It is thought that for these types of jobs it may be possible to render an electronic system which would automate the hiring process, and optimally remove or minimize the need for human intervention, by designing a system that would automate the process of selection and hiring of job candidates in such roles, subject only to satisfying post-hiring conditions such as a criminal record check, verification of any required certification, required physical attributes etc. If it were possible to provide a business system which would allow for unattended hiring on this basis it is believed that this would provide a substantial improvement over current state-of-the-art and be widely accepted.

In addition to satisfying the need to verify basic criteria qualifications for job candidates in these high turnover roles, the other primary tests that would be applied in a current state hiring environment would be the conduct of a brief interview in which an attempt is made to judge the personality and cultural fit of the candidate for the company and the role. Informally, managers conducting interviewing and hiring in such circumstances would be subconsciously seeking to match the personalities of potential job candidates to be hired with the personality characteristics of successful existing or past employees of the company in the same type of a job. The system of the present invention will automate and standardize testing for personality compatibility against the personalities of previous and existing successful employees in a company or across an industry, significantly improving upon the hiring process as would be found by quick, subjective interview approaches to verify personality compatibility. It is considered that the use of an automated personality matching system will actually enhance personality compatibility of new job candidates to be hired with the personalities of successful employees of the company in the role or similar roles previously, which will further enhance the commercial viability of a system in accordance with the present invention.

Successful employees against whom personality trait matching would be desired to be conducted could be identified from an existing employee management system, being the computer system containing various information about existing and past employees of an employer or across multiple employers in the same industry. Different characteristics of the employees could be used as indicative of a level of success or personality compatibility, including length of employment or the like.

It is believed that in most organizations, entry-level jobs or jobs the hiring for which can be based on an objective assessment as outlined in the present method can be divided into a small number of broad job categories. For example, customer facing or not customer facing, or a few other small categories such as manager or not manager which could be applied to the entirety of jobs in these groups to limit the number or type of customizations that need to be made in the personality matching process. By establishing a small number of broad job categories, all of the roles or jobs of multiple employers could be mapped into the same categories and could allow for the development of a system which would allow for the offer of a hiring process that allowed a potential job candidate to be matched against available jobs of multiple employers, using the same broadly defined personality matching process against the broad job categories into which each job of each employer could be mapped.

The overarching concept of the present invention is that by providing a system that permitted for criteria based matching of job candidates against available jobs of one or more employers, and including a personality matching element to the matching process based upon the personality traits of successful past or existing employees of a particular employer, a sufficient level of certainty in the computer-based matching process could be reached to remove the need for the conduct of interviews or human intervention in the hiring process. The desire is to provide a system that would permit an employer to post a job that needed to be filled, map that job into one of a small number of broad job categories on the system that generally speaking could dictate particular personality traits of interest or importance, and the remainder of the process including the conduct of personality profiles of successful existing or former employees as well as potential job candidates could be done in an automated process resulting in the automated offering of the job.

If it were possible to also provide a system that would not only provide a sufficient level of compatibility certainty to employers to permit them to accept an automated hiring process particularly in the high turnover roles, but also would allow a candidate having the personality traits and criteria to match a particular role to accept a job through user interface interaction with a mobile device or web interface interacting with a server of the method of the present invention, without the need for an interview or direct communication to take place, this would further accelerate the marketplace viability of the system and method of the present invention. Effectively, a hiring system that provided a sufficient level of hiring certainty to the employer to trust the decision being made by the system to allow the system to offer the job and have it accepted by the candidate without human intervention from the employer side—effectively permitting a “swipe to hire” system—is the ultimate goal here.

Such a system could also provide additional functionality in terms of the ability to refer additional job candidates between employers or open jobs etc. The add-on functionality which could be built upon the data and the model outlined in the remainder of this application will be understood to those skilled in the art.

### SUMMARY OF THE INVENTION

As outlined above and herein, it is the overall intention of the present invention to provide a computer implemented automated hiring method whereby employers can automate the hiring of compatible candidates for available jobs providing a matching engine that would permit the offering of jobs to candidates without employer intervention—in its broadest sense, effectively a “swipe to hire” system.

In a first embodiment the invention discloses a computer implemented automated hiring method whereby employers can automate the hiring of compatible candidates for available jobs using a system comprising a number of components. The first component of the system used in the method of the present invention is a server, having a processor and a memory and a network interface capable of communication with the client devices of employers, existing employees and candidates by at a wide area network, along with communicating with employee management systems of employers which house employee information of employees of the employer. Effectively, the server used in the system will act as a broker of information and information transactions between job candidates, employers, and successful current and past employees of employers having jobs to offer to be filled.

The system also comprises an employer database comprising an employer record for each employer using the method. The employer records will include the details required for the system to communicate with the employee management system of the corresponding employer, along with potentially including additional identifying information, authentication or credentials or the like.

A job database would also be accessible to the system which comprises a job record corresponding to each job sought to be filled by an employer in accordance with the method. In other embodiments of the invention, the employer could create a plurality of job records representing an inventory of all available jobs of the employer and the employer could simply update a flag for a particular job record indicating the digits available again for hiring—either approach to the structure of the job database is intended to be within the scope of the present invention.

There could be different structures for the storage of employer information as well. Details of the employer in respect of a particular job record could be stored within the job record, or in other embodiments as would be more likely the case there could also be an employer database comprised of a plurality of employer records, each employer record being capable of a one to many relationship to job records in the job database.

In embodiments in which employer database includes employer records, each job record would include a connection to a related employer record in the employer database, along with at least one job selection criteria for the job. Job selection criteria are selection criteria which successful candidates for the corresponding job must possess in order to be qualified for selection by the employer. These for example might be particular skills, physical attributes or the like that comprise base requirements for the position, for example, being able to lift twenty-five pounds, having first aid training etc. In addition to the selection criteria including successful candidate-based criteria, the job selection criteria might include employer-based or location based criteria which need to be matched—for example an employer with multiple work locations might include as a criteria the location at which a particular job is located which must be matched by a successful candidate as being a location where they would be interested to work etc. The job record in addition to including any identifying information and job selection criteria for the related job would also include an indication of any post-hiring conditions which would need to be required to be verified in respect of the successful candidate, following the acceptance of the automatically offered job in accordance with the method. There may or may not be post-hiring conditions to be met although in many cases there may be slight follow-up verification steps of the like which need to be conducted and can be conducted by the HR personnel of the employer etc.—for example a criminal record check, verification of the currency or completeness of the particular licenses, skills or certifications etc. Clearance of post-hiring conditions following an automatic hiring in accordance with the remainder of the method is the only area in which there may be required HR follow-up by the employer, following the offer and acceptance of the position and in advance of the commencement of employment.

Each job record in the job database will also include a job status indicator indicating the open or completed status of hiring for the job. Effectively, once a particular job corresponding to a job record is offered and accepted by a particular successful candidate, the job record corresponding to that job would be “deactivated” in the job database by altering the job status indicator from open to completed.

Additionally, the system would also include a candidate database which comprise the candidate record corresponding to each candidate seeking employment, and which can be used for matching and hiring in accordance with the remainder of the method. Each candidate record would include identifying information of the candidate, as well as candidate selection criteria. The candidate selection criteria are selection qualifications possessed by the candidate which can be matched against the job selection criteria in the job database to provide a job matching the first level degree of certainty between a particular position at a particular potential employee, based upon their qualifications, traits and skills, certifications etc. as well as satisfying any other employer criteria such as location and the like.

Each candidate record would also include a candidate status indicator indicating the available or hired status of the related candidate—effectively once the candidate accepts a position offered to them in accordance with the remainder of the method of the present invention the candidate record would be “deactivated” so as to not be considered in additional matching operations on the database by updating the candidate status indicator from available to hired.

It will be understood that the employer database, the job database and the candidate database could contain additional information in respect of employers, jobs and candidates to that outlined above—the items outlined above are the core or basic information required to practice basic embodiments of the method of the present invention

In addition to the databases outlined, which would contain the basic information required to practice the method of the present invention, the system would also include a hiring software component operable on the server and capable of executing the steps of the method. Specifics and variations on the construction or behaviour of the hiring software component will be understood to vary and any hiring software components which will achieve the desired outcome of executing the steps of the method as outlined are contemplated within the scope of the present invention.

In this first embodiment the system would execute a method comprising the creation and administration of records in the various databases in the system as well as conducting matching and hiring operations as outlined. As required, the system could interact with a client device of an employer to create employer records in the employer database for an employer desiring to hire using the method. In such a case, the server would capture from an employer client device employer identification information of the employer along with the details required for the server to communicate with the employee management system of that employer, and create and store corresponding employer record in the employer database.

An employer having a profile on the system and being able to authenticate thereto could also create available job records in the job database for each job for whom a candidate is desired to be hired. When the job record is required to be created, the server will interact with an employer client device to capture job data from the employer including at least job identifying information, employer identifying information by which the job record can be associated with the employer and their link to employer record, as well as any job selection criteria of the job. The server will then create a job record using the capture job data, including setting the job status indicator of the job record to open to indicate the associated jobs available for hiring.

A job candidate seeking to participate in the matching system and method of the present invention for the purpose of being hired could, using a client device in communication with the server, create a candidate record in the candidate database by transmitting candidate data to the server including at least candidate identifying information and candidate selection criteria of the candidate. The server would then create a candidate record using the captured candidate data, including setting the candidate status indicator of the created candidate record to indicate the associate candidate is available for hiring. The candidate record would be used for assessment of the compatibility of the candidate against available jobs on offer from multiple employers on the system.

Beyond facilitating the creation of records in the employer database, the job database and the candidate database as required, the system and the hiring software component would also facilitate a matching step in the method upon the detection of the existence of a scan condition in respect of the selected candidate record having an available status employment indicator. A scan condition would effectively be any database or environmental condition which should trigger the conduct of a matching pass through the databases to determine whether or not there are any available jobs to be offered to the candidate. The scan condition could be a periodic time frequency, a manual trigger by the candidate or a manual trigger of scanning of the entire database structure by the employer in question, or any other type of a condition which would initiate the matching step. Certain embodiments of the invention could be created in which either an employer or a candidate could manually trigger the existence of a scan condition—in some embodiments of the system and method of the present invention the manual triggering of a scan condition could be a premium feature which could be provided to either a candidate or an employer at a higher fee. Any type of a scan condition of this nature is contemplated to be within the scope of the present invention.

On the detection of the existence of the scan condition, the matching step would be conducted by the system. The matching step comprises first selecting any job records with an open status, being open job records from the job database.

Following the selection of a subset of open job records from the job database, the hiring software component would then qualify the selected candidate record against any open job records by seeking to match the candidate selection criteria of the selected candidate record with the job selection criteria of each open job record. Depending upon the nature of the system and the desires of particular employers, this matching process could require a complete match between all criteria between the added at the job, or could be configured to permit the matching of a candidate record with a particular job record if the candidate selection criteria and the job selection criteria were similar enough to be within a configurable or selectable threshold. Both such approaches are contemplated within the present invention. Any open job records for which a match exists with the selected candidate record are qualified job records.

Continuing in the matching step if there is at least one qualified job record, the system of the present invention would facilitate an offer, being an unattended offer of employment of any of the jobs corresponding to the qualified job records, to the selected candidate. The offer step would be conducted by presenting to a user interface of a candidate client device of the candidate in question the details of the match to jobs corresponding to each qualified job record. The candidate would be permitted to accept one of the matched jobs displayed corresponding to a qualified job record by a user interface interaction by the interface of the candidate client device. Effectively this interface display of available qualified job records and the potential to accept one of the matched jobs comprises the offer and acceptance of the related job being facilitated without human intervention by the employer.

If the candidate accepts a job in the user interface interaction, the job status indicator of the corresponding job record would be updated to indicate that the job is no longer available for hiring, and the candidate status indicator of the corresponding can be updated to hired status, indicating that the selected candidate is no longer seeking employment. A user interface confirmation communication could be provided to the candidate by their candidate client device confirming acceptance of the job subject only to the validation of post-hiring conditions outlined in the corresponding job record, and the details of the corresponding candidate record and job acceptance would [could?] be transmitted to the employee management system of the corresponding employer for the completion of confirmation of post-hiring conditions if any and the initiation of the employment relationship.

Keys to the method of the present invention include the fact that the hiring of employees in accordance with the method takes place without user interaction or intervention on the part of the employer during the hiring process, following the establishment of the necessary database records, and the acceptance of a matched job by a candidate in accordance with the method is subject only to validation of the prescribed post-hiring conditions by the employer and in all respects constitutes the formal receipt and acceptance of an offer of employment subject only to those post-hiring conditions.

Different types of user interface interactions will be understood to those skilled in the art of software interface design, depending to a degree upon the nature of the software used that the client and to interact with the server of the present invention as well as the type of client device. Considering that the client device being used would in most circumstances probably comprise a smart device, such as a mobile telephone, tablet or the like, a single touch interface interaction such as a swiping motion or the like on the job desired to be accepted could comprise the user interface interaction, or in other designs, selecting the desired job to be accepted, if any, on the interface of the client device and then making a confirmatory indication of acceptance are a couple of options. A confirmation indication of acceptance could be a single interface click on the interface of the candidate client device, or the like. Any type of an interface interaction permitting the streamlined indication by a candidate of the acceptance of an offered position will be understood to be within the scope of the present invention.

Many types of candidate selection criteria could be stored in the candidate record for the exercise of the method of the present invention. These could include candidate selection criteria selected from the group of desired location of employment, physical or mental attributes or skills of the candidate for consideration in hiring for a particular type of job or position, or certifications or licenses held by the candidate etc. The types of candidate selection criteria which could be used in the present invention will be understood to those skilled in the art to be virtually limitless and any type of candidate selection criteria is contemplated within the scope of the present invention.

Similarly, the job selection criteria stored in a particular job record could also be of infinite types without departing from the intended scope hereof. The job selection criteria could be selected from the group of employer location, physical or mental skill requirements of the successful candidate for a job, or certification or licensing requirements or the like of the successful candidate. It will be understood that any type of a job selection criteria as will be understood to those skilled in the art of hiring are all contemplated within the scope of the present invention.

Inclusion of post-hiring conditions required to be verified in respect of the successful candidate in a particular job record is optional. There may be certain cases in which there are no post-hiring conditions to be met and other cases in which there are a number of post-hiring conditions required to be verified. Where there are post-hiring conditions required to be verified these could be again infinite in nature although it is primarily contemplated that they would comprise quick verification for example of a successful completion of a criminal record check, verification of the current status of training or certifications and qualifications or the like. It will be understood that any type of a contingency as will be understood to those skilled in the art of hiring as potentially being verified post offer and acceptance of the position are understood to be within the scope of the present invention.

In additional embodiments of the present invention beyond those matching candidates and potential jobs on the basis of job and candidate selection criteria and providing the ability for the simplified interface interaction as a hiring action or step as outlined above, additional embodiments of the present invention are intended at a higher level of comfort or certainty in terms of candidate compatibility for employers, to cause them to accept the automated or noninterventionist method of the present invention. For example, in certain embodiments of the system, the employee information stored by the employee management system of an employer includes employee information of existing or past employees which included job category indicator and job performance data for each existing or past employee. Various types of job performance data will be stored in these employee management systems, including for example the length of employment which is seen as one key indicator of personality compatibility and indicator of employee success—if employees remain employed in the same role or with the same employer for a longer period of time there is obviously a compatibility of personality with the roles they are working in and the employer work culture. Job performance data including the length of tenure of employees as well as other attributes or performance data will be understood to be useful in the personality/behavioural profiling outlined herein which is intended to provide a higher level of certainty in the qualification of candidates and all such job performance data are contemplated to be within the scope of the present invention.

It is also explicitly contemplated that the system and method of the present invention could comprise a stored standardized list of system job categories against which each job record of each employer is matched. By imposing a standardized set of system-level job categories upon all positions listed in the system, embodiments of the invention will permit criteria and trait comparison across multiple employers, allowing for the provision of a multiple employer portal through which a candidate could seek employment with multiple employers and the multiple employers would have a reasonably standardized set of job categories and related criteria imposed thereon for the sake of matching.

In embodiments of the system and method of the present invention in which the employee information stored by employee management systems of each employer include job category indicators and job performance data, and there is a systemwide set of standardized system job categories against which each individual job category indicator of each employer is mapped, employer records stored within the employer database could also comprise stored data corresponding to a quantitative employee success index for each system job category against which at least one employee from the corresponding employee management system is mapped. The quantitative employee success index is contemplated to represent one or more numerical scores representing personality characteristics of successful existing or past employees of the employer in jobs corresponding to the system job category in question. Creation of the employer record in embodiments such as this would further comprise establishing a network connection between the server and the employee management system of the employer, and querying the job performance data within the employee management system to identify a plurality of successful existing or past employees corresponding to each system job category against which at least one employee from the corresponding employee management system is mapped, being successful employees.

Following the identification of successful employees, the server would determine and store the quantitative employee success index for each system job category against which at least one employee from the corresponding employee management system is mapped, using the job performance data of the successful employees for that system job category. The quantitative employee success index could be established based upon a direct calculation applied to job performance data at the successful employees for that system job category, or a machine learning or other artificial intelligence-based function could be applied to the job performance data of the successful employees for that system job category to yield the quantitative employee success index.

In certain embodiments, the quantitative employee success index would be informed in its determination not only by job performance data from the related employee management system but also by the conduct or administration of a standardized quantitative personality assessment to each of the selected successful employees. In such embodiments, the selected successful employees would be requested by the server, in communication with client devices of the successful employees, to facilitate or participate in a standardized quantitative personality assessment. The server would administer the standardized quantitative personality assessment to each of the successful employees by their client devices and capture the results of the same at the server. Administration of a standardized quantitative personality assessment will be understood by those skilled in the art to comprise the provision of an interactive browsing or client session with the client device of the successful employee in communication with the server in which certain standardized quantitative personality assessment answers could be provided. Any type of a standardized quantitative personality assessment could be developed, or pre-existing tools used, and all such approaches are contemplated within the scope of the present invention.

The results of the standardized quantitative personality assessment of the successful employees would then be used in the determination of the quantitative employee success index for each system job category. For example, individual or group level mathematics or machine learning functions could be applied to those personality assessment results, the collated results or processed results of which could be reflected in the quantitative employee success index.

A single quantitative employee success index could be established for each employer having an employer record in the employer database, or separate quantitative employee success indexes could be established for each system job category having at least one employee of an employer mapped against it. Both such approaches are contemplated within the scope of the present invention. Similarly, the same standardized quantitative personality assessment could be conducted in respect of all successful employees identified in respect of an employer, or different standardized quantitative personality assessments could be used for different successful employees in different system job categories. Also, the same standardized quantitative personality assessment could be conducted in respect of all successful employees of a particular employer, but it is more likely the case that the provide the broadest matching methodology, the same standardized quantitative personality assessment would be used across successful employees of all employers on the system, to provide matching indexes of the broadest possible relevance for employment options and opportunities with multiple employers. All such approaches are contemplated within the scope of the present invention.

In embodiments of the system and method of the present invention in which a quantitative employee success index is created, representing behavioural traits of successful employees of an employer, for matching purposes, the next step would further comprise the creation and storage of a quantitative candidate compatibility index in a candidate record, representing personality characteristics of a particular candidate to which a candidate record relates. The creation and storage of the quantitative candidate compatibility index would comprise, during the creation of the candidate record, using the system in communication with the candidate client device to administer the same standardized quantitative personality assessment to the candidate and capturing the results of same at the server. Based upon the received results of the personality assessment, a quantitative candidate compatibility index could then be determined or established using various math or machine learning functionality, and the same can be stored to the candidate record.

As in the case of the employer compatibility index, the candidate compatibility index could be established based upon a direct calculation on the results of the personality assessment of the candidate, or in other embodiments, the quantitative compatibility index of the candidate to be established using a machine learning function relying upon personality assessment results received and stored in the candidate record, along with optionally accessing external datasets corresponding to the candidate. Where external datasets corresponding to the candidate were accessed or use those could be selected from the group of social graphs, credit score data and the like. Any type of an external dataset which could be used to further inform the formulation of a reliable quantitative candidate personality index as will be understood to those skilled in the art is contemplated within the scope hereof.

In embodiments of the system and method of the present invention that include the personality matching indexes for employers and candidates outlined above, the matching step would further comprise the conduct of a profile matching step in respect of any qualified job record following the determination of the existence of any qualified job records, where the software would compare the candidate compatibility index stored with a selected candidate record to the employee success index of the related mapped system job category stored in association with the employer record matched to the qualified job record. If the candidate compatibility index does not meet a desired configurable threshold equivalence with the employee success index of the employer, the qualified job record would no longer be considered a qualified job record, and conversely if it is determined that there is a threshold equivalence between the candidate and the job based on the comparison of these indexes for the employer and the candidate yielding a confirmed qualified job record, the corresponding job can be offered. Embodiments of this nature will ensure the threshold level of personality compatibility between the selected candidate and any jobs to be offered corresponding to the qualified job records. In embodiments such as this, where qualified job records are verified to be jobs for which a particular selected candidate is qualified not only based on job criteria but also in behavioural or personality matching, the highest threshold of certainty and matching is achieved which can permit employer confidence in trusting the automated hiring method.

It is specifically contemplated that the system and method of the present invention will be offered by a client/server Internet-based system. The network could be the Internet, and the server could be a Web server capable of communication with mobile or remote client devices operatively connected to the network and capable of communicating with the server via a web interface or other software served or engaged in communication therewith or therefrom.

It is specifically contemplated that the system and method of the present invention would be offered on behalf of a plurality of employers i.e. the number of employer records would be more than one, resulting in the ability to offer a service bureau to multiple employers and the ability for job candidates to be considered for jobs with multiple employers at the same time through a single registration and profiling process.

In addition to the method of the present invention and the various embodiments outlined above providing a computer implemented hiring method for employees, whereby employers can automate the hiring of compatible candidates for available jobs without human employer intervention in the hiring process, the invention also comprises the system to be used to facilitate the various embodiments of the method. The first component of the system used in the method of the present invention is a server, having a processor and a memory and a network interface capable of communication with the client devices of employers, existing and former employees and candidates via a wide area network, along with communicating with employee management systems of employers.

The system also comprises an employer database comprising an employer record for each employer using the method. The employer records will include the details required for the system to communicate with the employee management system of the corresponding employer, along with potentially including additional identifying information, authentication or credentials or the like.

A job database would also be accessible to the system which comprise the job record corresponding to each job at a system employer to be filled. Each job record would include a connection to a related employer record in the employer database, along with at least one job selection criteria for the job. Job selection criteria are selection criteria which successful candidates for the corresponding job must possess in order to be qualified for selection by the employer. The job record in addition to including any identifying information and job selection criteria for the related job would also include an indication of any post-hiring conditions which would need to be required to be verified in respect of the successful candidate, following the acceptance of the automatically offered job in accordance with the method. Each job record in the job database will also include a job status indicator indicating the open or completed status of hiring for the job. Effectively, once a particular job corresponding to a job record is offered and accepted by a particular successful candidate, the job record corresponding to that job would be “deactivated” in the job database by altering the job status indicator from open to completed.

Additionally, the system would also include a candidate database which comprise the candidate record corresponding to each candidate seeking employment, and which can be used for matching and hiring in accordance with the remainder of the method. Each candidate record would include identifying information of the candidate, as well as candidate selection criteria. The candidate selection criteria are selection qualifications possessed by the candidate which can be matched against the job selection criteria in the job database to provide a job matching the first level degree of certainty between a particular position at a particular potential employee, based upon their qualifications, traits and skills, certifications etc. as well as satisfying any other employer criteria such as location and the like.

Each candidate record would also include a candidate status indicator indicating the available or hired status of the related candidate—effectively once the candidate accepts a position offered to them in accordance with the remainder of the method of the present invention the candidate record would be “deactivated” so as to not be considered in additional matching operations on the database by updating the candidate status indicator from available to hired.

The employer database, the job database and the candidate database could contain additional information in respect of employers, jobs and candidates to that outlined above—the items outlined above are the core or basic information required to practice the most basic embodiments of the method of the present invention but for additional more complicated embodiments of the method of the system, additionally stored information in the records of any of those databases will be understood to be within the scope of the present invention.

In addition to the databases outlined, which would contain the basic information required to practice the method of the present invention, the system would also include a hiring software component operable on the server and capable of executing the steps of the method.

The system of the present invention will be capable of conducting various embodiments of the method of the present invention as outlined above.

Overall it will be understood that the system and method of the present invention will permit the unattended hiring of candidates for selected posted to jobs with employers, through a simple and straightforward user interaction process with the interface of a client device of the job candidate and in many embodiments of the method including a high level of certainty for the employer based upon a personality matching system matching the traits of candidates with the traits of successful existing or former employees of the employer. The system and method of the present invention will also succeed in offering a streamlined candidate matching and hiring system which removes any potential for discrimination bias from the hiring process.

### DESCRIPTION OF THE DRAWINGS

To easily identify the discussion of any particular element or act, the most significant digit or digits in a reference number refer to the figure number in which that element is first introduced. The drawings enclosed are:

FIG. 1 is a schematic diagram of one embodiment of the system of the present invention including client devices for demonstrative purposes;

FIG. 2 is a block diagram demonstrating one embodiment of basic data structures of the databases of the system of FIG. 1.

FIG. 3 is a block diagram demonstrating the key components of one embodiment of the server in accordance with the present invention;

FIG. 4 comprises a flowchart demonstrating the steps of the first embodiment of the method of the present invention;

FIG. 5 is a flowchart showing the steps in one embodiment of a employer record creation subroutine for association with FIG. 4;

FIG. 6 is a flowchart showing the steps in one embodiment of a job record creation subroutine for association with FIG. 4;

FIG. 7 is a flowchart showing the steps in one embodiment of a candidate record creation subroutine for association with FIG. 4;

FIG. 8 is a flowchart showing the steps in one embodiment of a candidate matching subroutine for association with FIG. 4;

FIG. 9 comprises a flowchart demonstrating the steps of a second embodiment of the method of the present invention which includes personality matching aspects;

FIG. 10 is a flowchart showing the steps in one embodiment of a job record creation subroutine for association with FIG. 9;

FIG. 11 is a flowchart showing the steps in one embodiment of a candidate record creation subroutine for association with FIG. 9;

FIG. 12 is a flowchart showing the steps in one embodiment of a candidate matching subroutine for association with FIG. 9;

FIG. 13 is a sample mockup of the screen which could be shown to a candidate in the process of a scanned step and the offering of a job, through which a user interface interaction could take place; and

FIG. 14 is a sample mockup of the screen demonstrating a confirmation of an accepted position for a candidate.

### DETAILED DESCRIPTION OF ILLUSTRATED EMBODIMENTS

As outlined herein, the present invention comprises a system and method for use in the hiring of employees through an electronic system negating the need for human intervention of employers in the hiring process from the time of listing the job to the time of acceptance thereof.

### Entities

There are a number of entities to be considered in understanding the operation and efficacy of the method of the present invention. The system is intended to enable employers having jobs to fill to offer those jobs for matching in accordance with the system of the present invention. An employer seeking to match a single job to a candidate or a large number of jobs even of the large number of locations to a larger number of candidates would be equally as able to benefit from the time optimization of the system outlined. In order for embodiments of the present invention which include personality profiling and matching to work effectively, an employer would need to have an employee management system which is a computer system containing job and tenure data of existing and previous employees, from which successful employees could be chosen as outlined elsewhere herein. In cases of the employee management system being operatively connected to a computer network, the server of the present invention could query its contents—in some cases the employee management system might even be another SaaS platform available on the Internet with appropriate credentials and the system and server of the present invention could be effectively equipped and programmed to access same. In other embodiments, the employer might use an off-line or on premises employee management system in which case the employee management system element of the present invention could be at data file exported from that off-line system. Both such approaches are contemplated within the scope of the present invention.

Employers have employees, each of whom inhabits a job. Filling empty jobs is the primary intention of the system of the present invention. Different types of jobs, within the overarching scope of the categories of jobs for which the method would be effective, can be classified into different categories. For example, in a restaurant there might be waiters, cooks, dishwashers or the like. In a grocery store there might be shelf stocking personnel, cashiers etc. A particular employer might have one or more than one employee within each employer level job category.

### Service Bureau

While the system and method of the present invention could be practised on behalf of a single employer i.e. it could be used to catalogue and offer jobs only with one employer at one or more locations for example, it is explicitly contemplated that the more effective embodiments of the system of the present invention would be offered in behalf of a plurality of employers. I.e. job candidates seeking jobs could be matched by the system with available positions of multiple employers, which would make the system and method more desirable to candidates and could thus generate a larger pool of candidates for matching purposes on behalf of all of the employers. Offering the system and method of the present invention to multiple employers in a single system, on this basis such that available jobs of multiple employers could be matched to candidates creating a candidate record in a single system, is explicitly contemplated within the scope of the present invention.

In addition to employers and jobs, the next entity per se that needs to be understood from the perspective of the current invention is the concept of a job candidate. A job candidate is an individual seeking employment and seeking to be matched with a job that might be offered in the system of the present invention.

### Job Selection Criteria

Each job of an employer would have at least one job selection criteria associated with it. These would be hiring criteria for potential employees, or other employer level criteria which might apply to the position. For example a job selection criteria might be the actual employer location at which the employment would be located. Job selection criteria might also include physical or mental skills or attributes of a successful employee which might be required for the particular nature of the position. For example a dockworker might need to be able to lift a certain amount of weight or something like that which could be a job selection criteria. Other job selection criteria might include particular licenses, training or certifications that needed to be held by a successful candidate. Any type of a personal attribute or a job or employer level attribute which could be used for the purpose a first stage match of an available job candidate to the position would be within the scope of job selection criteria as described in intended.

### Post-Hiring Conditions

Certain jobs might also have post-hiring conditions associated with them. Post-hiring conditions, for the purpose of the lexicon of the remainder of this document, are conditions which might need to be cleared following the acceptance of the job to confirm the entitlement durability of the employee to start work. For example, a job might be accepted subject to the condition that the candidate needs to pass a criminal record check, identity verification, confirm the current state of particular licenses or training etc. and that the job offered is offered on the condition that those post-hiring conditions would be cleared in order for the employee to start work. Some jobs may not have any post-hiring conditions associated with them. Both such approaches, namely with or without post-hiring conditions/conditions for clearance post acceptance of employment are contemplated within the scope of the present invention.

### Candidate Selection Criteria

Each candidate has candidate selection criteria associated with them which would be stored in candidate records corresponding to the candidates in accordance with the remainder of the method. The candidate selection criteria would be, from a matching perspective, the other half of the job selection criteria outlined above. For example, candidate selection criteria might include the amenability of a candidate to work in particular locations, their physical or mental training or ability in terms of particular jobs i.e. in the example of a dockworker outlined above, that they can they lift 50 pounds or more. Other candidate selection criteria might include the fact that the candidate holds particular training, licenses or certifications etc. Any type of a selection criteria which could be used to match a candidate to a particular available job are contemplated to be candidate selection criteria as outlined.

### System Job Categories

It is specifically contemplated that the system of the present invention might have a system level set of job categories defined, against which each job category of each employer could be mapped for the purpose of providing the ability to match and compare job candidates to approximately similar jobs across a plurality of employers and to provide a simplified matching process that would allow for matches to be undertaken across a multiple of employers by generally speaking characterizing each position offered by an employer in a particular system-level job category. The system-level job categories could be further defined in a way that they had specific calculations or methodologies associated with each of them for the purpose of assessing an employee success index etc., but the overarching concept of a standardized set of system-level job categories will be understood to be within the scope of the present invention for the purpose of allowing comparison and matching of job candidates with jobs offered by multiple employers each of whom have categorized their available positions within the system-level job categories.

### Employee Success Index

For embodiments of the system and method of the present invention that includes the behavioural/personality matching element to increase the level of certainty in matching as well as the level of competence of employers in the success outcomes to be afforded by the system, an employee success index would be calculated in accordance with the remainder of the invention and stored in respect of an employer, or each system-level job category in which the employer has positions listed for filling and matching. The employee success index is specifically contemplated to be a quantitative measure, or plurality of measures, which could be used for matching purposes and which would effectively represent the desirable personality traits of successful employees of the employer. As will be disclosed elsewhere herein, the employee success index or indexes could be the result of direct calculations applied to personality assessment outcomes of previous and successful employees of the employer, or could be rendered using an artificial intelligence or machine learning component or function.

### Personality Assessment for Successful Employees

A personality assessment for successful employees would be used to determine the employee success index for a particular employer or particularly system-level job category of an employer. The personality assessment is explicitly contemplated to be an objective personality survey or quiz which could be electronically administered quickly by the server of the present invention to a device of a successful existing or prior employee of the employer. The results of the personality assessments completed by successful employees of the employer could be used in aggregate to render the employee success index for that particular employer and system-level job category. It is likely that the objective personality survey would be administered to successful existing employees at the employer, but it could also be provided to a prior employee who fit within the category of successful employment with the employer.

It is explicitly contemplated that the personality assessment tool which would be used would be the same tool across all employers, so that similar methodology would be used in rendering the measurement of personality traits of employees in each case and would result in the best normalized employee success indexes for different employers, so that job candidates could be successfully matched with available positions from multiple employers. Categorization and mapping of existing jobs of each employer on the system to that systemwide set of job categories is also important for this purpose, since each systemwide job category could have a different or modified personality assessment tool associated therewith, or the same personality assessment tool could be used for all employees in all job categories and the calculation of the employee success indexes for different job categories could be modified based upon the requirements of those categories. Any such approaches are contemplated within the scope of the present invention.

### Candidate Compatibility Index

For embodiments of the system and method of the present invention include the behavioural/personality matching element to increase the level of certainty matching as well as the level of confidence of employers in the system and its outcomes, a candidate compatibility index would be calculated in accordance with the remainder of the invention and stored in respect of a particular job candidate the candidate compatibility index is specifically contemplated to be a quantitative measure or plurality of measures which could be used for matching purposes in which would effectively represent the actual personality traits of the candidate which could be matched against the desirable personality traits represented by the employee success index of a particular position, system-level job category of an employer, or employer. The candidate compatibility index or indexes could be the result of direct calculations applied to personality assessment outcomes of the candidate, or could be the result of the application of a machine learning component or function to the personality assessment outcomes of the candidate further supplemented by access to external datasets corresponding to the candidate such as credit history, academic outcomes, social graphs, genetic markers and the like. The result of the determination of the candidate success index for a particular candidate would be stored in the corresponding candidate record for matching purposes with various job records of employers in accordance with the remainder of the method outlined herein.

### Personality Assessment for Job Candidates

On registering with the system of the present invention to be matched with available jobs, a job candidate would also need to complete a personality assessment. The personality assessment tool used and administered to the job candidate would be the same personality assessment tool administered to successful employees of the employer or employers in the related systemwide job category. Basically, by using the same personality assessment tool with job candidates as is used with successful employees, the similarity in scoring and outcomes on the personality assessment tool between those two audiences can be used to impute a likelihood of compatibility of a particular job candidate with a particular job based upon a similar set of results on the personality assessment tool to successful employees in the same category. The personality assessment of both successful employees as well as job candidates will be capable of rendering in a quantitative form, so that the similarity between the results for a job candidate versus the successful employees of an employer can be compared numerically or quantitatively within a particular threshold of similarity which could be established or adjusted by the employer on a job-by-job basis if desired.

### System and Architecture Overview

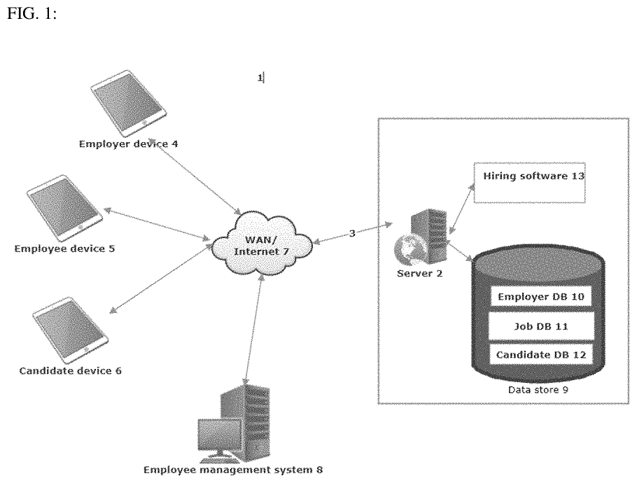

For the purpose of describing the method of the present invention we will now describe briefly the overall architecture of the system 1 of the present invention as required for the purpose of describing the invention. Referring to FIG. 1 there is shown a schematic diagram of the system 1 of the present invention. The system 1 comprises a server 2 having a network interface 3 capable of communication with employer client devices 4, employee client devices 5 of existing and past successful employees of employers, and candidate client devices 6 of job candidates interested in consideration or matching in accordance with the method. The employer client devices 4, employee client devices 5 and candidate client devices 6 are shown connected to the server 2 via the Internet 7.

The server 2, via the network interface 3, is also capable of communicating with the employee management systems 8 of various employers. An employee management system 8 is shown, also operatively connected to the server 2 by the Internet network 7.

The server 2 would also include or be operatively connected to a data store 9, capable of hosting or containing a plurality of databases for the practice of the method of the present invention. Shown are the employer database 10, the job database 11, and the candidate database 12. Details of an example of a data structure for these databases are shown in subsequent Figures.

In addition to the necessary other software and hardware components of any type of the server 2, the server 2 also includes as an additional component particularly required for the practice of the method of the present invention a hiring software component 13, operable on the server and capable of executing the steps of the method.

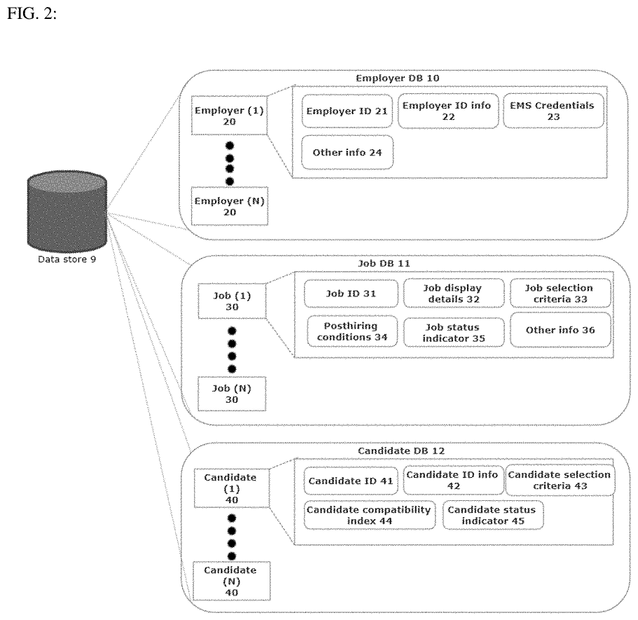

Referring to FIG. 2 there is shown a sample of one type of a demonstrative data structure for the data store 9 and the employer database 10, job database 11 and candidate database 12. Each of these three databases 10, 11, 12 are shown in this Figure. As will be obvious to those skilled in the art other types of data structures could also be used in which each of the three databases 10, 11 and 12 could be data residing within a single database structure. Either a single consolidated dataset for individual or silo databases will be understood to be within the intended scope of the present invention.

The employer database 10 consists of a plurality (N) an employer records 20, corresponding to each employer using the system and method of the present invention. Each employer record 20 includes the necessary fields or data to practice the method—in basic embodiments, the employer record 20 would include a serial key or employer identifier 21, any employer identifying information 22 as well as any necessary credentials 23 or other information required to allow the server 2 to authenticate and communicate with the employee management system 8 of the corresponding employer. It will be understood to those skilled in the art of database design and the design and execution of various hiring and the system method such as that outlined herein that additional functionality could be added to the system and method of the present invention that might require the storage of additional employer related information in the employer database 10, and the data structure of each employer record 20 could be modified accordingly and is contemplated with any such modification to remain within the scope of the invention as described and claimed herein.

The job database 11 consists of a plurality (N) of job records 30, each of which corresponds to a job offered for matching and hiring purposes by an employer in accordance with the remainder of the present invention. Each job record 30 includes the necessary fields or data to permit display of relevant information for display to job candidates considering the offering of such position as well as the necessary additional information for the purpose of matching candidates to the related job. In the embodiment shown, the job record 30 includes a serial key or job identifier 31, as well as a relational database key 21 back to the corresponding employer record 20. Additionally, the job record 30 as indicated will contain any necessary information 32 for display to candidates in the offer of the related job. Also shown are data structures for the storage of job selection criteria 33, used to match candidates to the related job.

The job record 30 also includes details of any post hiring conditions 34 which must be verified or cleared in respect of the candidate following hiring for the position question. Finally in the data structure shown, the job record 30 also includes a job status indicator 35, indicating the open or completed status of hiring for the job in question. The job record 30 might also include a number of other different fields or information 36 required for the facilitation of the method of the present invention, including keys for matching the job record 30 back to a particular category of positions listed in the employee management system of the associate employer, stored calculated versions of the employee success index calculated in respect of the particular job record 30 in the underlying position, or other information as might be required in the execution of various embodiments of the system of the present invention and all such information will be understood to be within the scope hereof.

Referring next to the candidate database 12, the candidate database 12 would consist of a plurality of candidate records 40 each of which corresponded to a particular candidate seeking hiring in accordance with the method of the present invention. The candidate record 40 would include in this embodiment a serial identifier 41, candidate identifying information 42 which could be stored for the purpose of passing on to the employee management system of a employer where a successful manager hire was completed, as well as candidate selection criteria 43, namely details of the selection qualifications possessed by the candidate which can be used for matching purposes. In the embodiment shown there is also a data structure for the storage of a candidate compatibility Index 44, as well as a candidate status indicator 45 which indicates the available or hired status of the candidate in question in accordance with the remainder of the method.

### Server

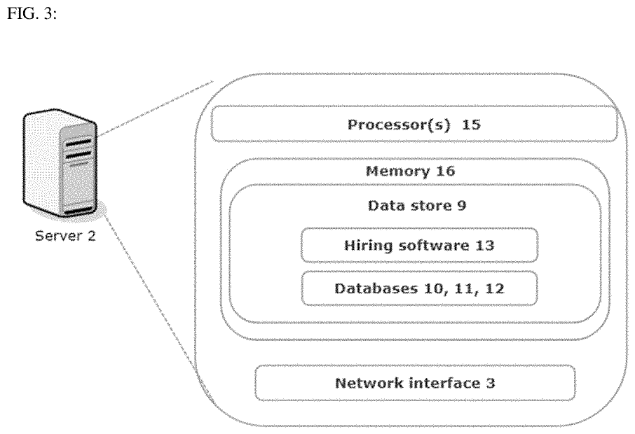

FIG. 3 shows one embodiment database server 2 in accordance with the present invention. The method of the present invention and the overall architecture would be client/server in nature and would rely on a server 2 configured for use in the processing of position matching and hiring transactions in accordance with the method. The server 2, a sample embodiment of which is shown in FIG. 3, might consist of one or more servers 2—a single server or a server farm approach. The server 2 would comprise one or more processors 15 and memory 16. The memory 16 might contain various software components or a series of processor instructions for use in the method of the present invention or otherwise in the operation of the server 2. Processor instructions corresponding to the hiring software component are shown stored within the memory 16 in this Figure.

Memory 16 may comprise non-transitory storage media that electronically stores information. The electronic storage media of memory 16 may include one or both of system storage that is provided integrally (i.e., substantially non-removable) with server(s) 1 and/or removable storage that is removably connectable to server(s) 1 via, for example, a port (e.g., a USB port, a firewire port, etc.) or a drive (e.g., a disc drive, etc.). Memory 16 may include one or more of optically readable storage media (e.g., optical discs, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. Memory 16 may include one or more virtual storage resources (e.g., cloud storage, a virtual private network, and/or other virtual storage resources). Memory 16 may store software algorithms, information determined by processor(s) 15, information received from server(s) 2, information received from client devices, and/or other information that enables server(s) 2 to function as described herein.

Processor(s) 15 may be configured to provide information processing capabilities in server(s) 2. As such, processor(s) 15 may include one or more of a digital processor, an analogue processor, a digital circuit designed to process information, an analogue circuit designed to process information, a state machine, and/or other mechanisms for electronically processing information. In some implementations, processor(s) 15 may include a plurality of processing units. These processing units may be physically located within the same device, or processor(s) 15 may represent processing functionality of a plurality of devices operating in coordination.

In many embodiments, the server 2 is contemplated to be a Web server, where client devices would use a web browser for interaction therewith. Where a local app was developed, server 2 might not be a Web server per se but might be a server 2 capable of interaction with that type of an interface on remote client devices. Either such approach is contemplated within the scope hereof.

Server 2 would also include at least one network interface 3 via which it could communicate with the at least one communications network for the purpose of enabling communication with the client devices and employee management systems of the remainder of the method as outlined herein. It will be understood by those skilled in the art of network design and hardware and software design that certain server architectures might include more than one network interface 3 and any type of a server 2 and network interface 3 design which enabled the communication of the server 2 as outlined in the remainder of the method would all be contemplated within the scope of the present invention.

### Hiring Software Component

The hiring software component 13 resident on or accessible to the server 2 would be key to the performance of the present method. Functions of the hiring software component 13 would include the creation, administration and maintenance of database records within the databases 10, 11, 12, along with interacting with client devices as required for the purpose of facilitating the method. The hiring software component 13 could also encompass any additional required querying, reporting or added software functionality.

The hiring software component 13 will comprise any compiled processor instructions capable of being executed by the processor of the server 2. It will be understood that any hiring software component 13 having the effect of being able to administer the method of the present invention as outlined is contemplated within the scope of the present invention.

### Method Overview

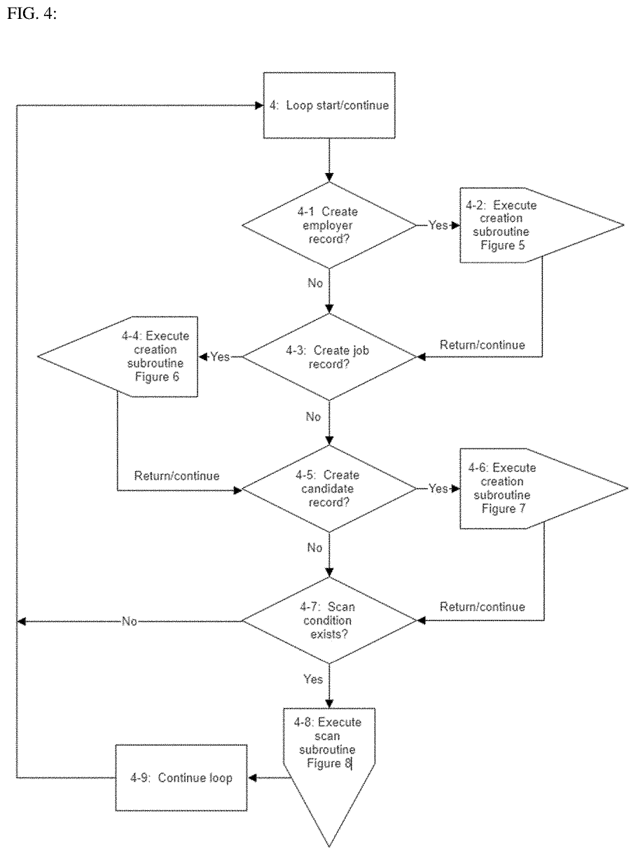

FIG. 4 is a flowchart demonstrating the steps of the first embodiment of the method of the present invention, in which job candidates can be automatically matched with available employer job positions and can accept an offered job with a simple user interface interaction. The method, as executed by the hiring software component 13 in accordance with the remainder of the system of FIGS. 1 to 3, would as demonstrated be conducted in a perpetual loop fashion, although it will be understood to those skilled in the art of software design that there are many different orderings or approaches to the steps in the method as outlined which would still achieve the same objective and would not depart from the intended scope claimed herein.

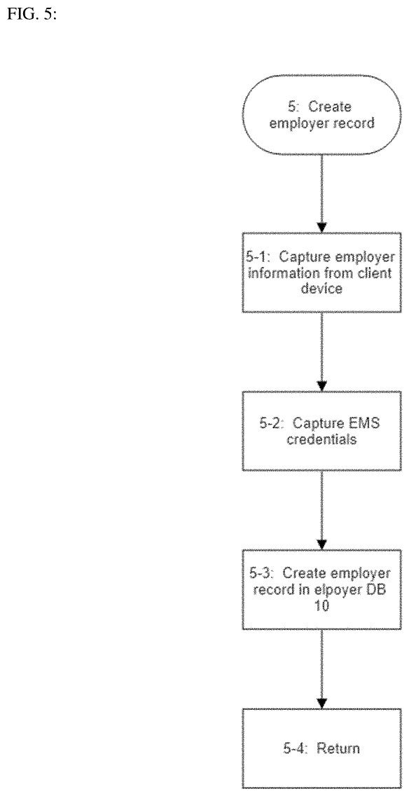

The method shown in this Figure is a listener/repeat loop. A listener would determine if there was a requirement to create an employer record for a new employer in the system—likely by initiation of a communication session with an employer client device for this purpose. If a user interaction from an employer client device is detected requiring the creation of an employer record 20, an employer record creation subroutine is executed before returning to the primary repeat loop. Detection of the condition requiring creation of an employer record is shown at step 4-1, and the off page execution of the creation subroutine of FIG. 5 is shown at step 4-2.

If it is desired to create an employer record 20 and the subroutine of FIG. 5 is activated, the server 2 in communication with an employer client device would capture employer identification information 22 as well as authentication credentials or other connection information 23 for initiation of a communication session with the employee management system 8 of the employer. Capture of this information via a user interface interaction between the server and the employer client device is shown at 5-1 and 5-2. Following the capture of this and any other relevant information, the software would create an employer record 20 in the employer database 10 as shown at step 5-3, and the subroutine would return control to the primary method. With the subroutines shown and the structure of the main method of FIG. 4 etc. variations in the approach without departing from the ultimate results will be understood to those skilled in the art of software design and any methods and subroutines resulting in the ability to maintain the employer, job candidate datasets as well as conduct matching steps as required will be understood to be within the scope of the present invention.

In embodiments of the present invention where the employer subject of the employer record 20 use that off-line employee management system such that a census file for an off-line data file exported from a off-line system would comprise the actual employee management system element of the method, the creation of the employer record 20 could actually comprise the upload of the data file for storage along with the remainder of the employer information in association with the employer record 20. As outlined elsewhere. It will be understood that either a life connection between the server of the present invention and the employee management system 8 of the employer, or other systems where the employee management system 8 element comprised of a data file stored in association with the corresponding employer record 20 which was exported from time to time from an off-line or on premises system of the employer, are both contemplated within the scope of the present invention.

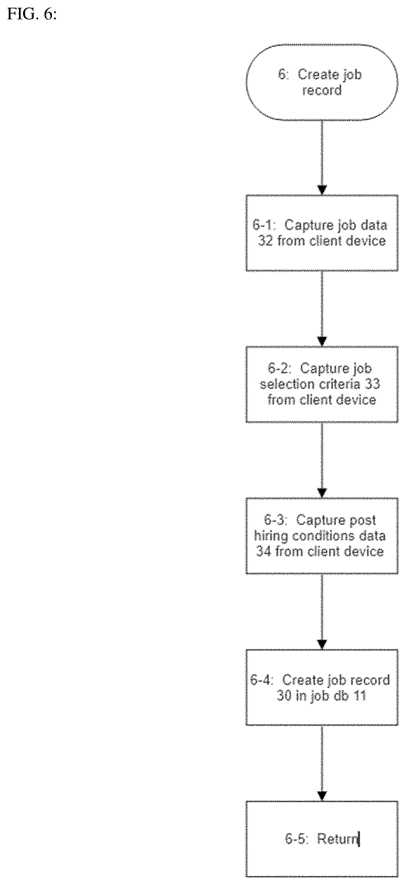

Returning to FIG. 4, shown next at 4-3 is another listener seeking indication of the requirement for the creation of a job record 30 in the job database 11. Upon initiation of a communication session or interaction for the creation of a job record 30, or receipt of indication from a client device indicating a desire to create a job record, a job record creation subroutine is executed before returning to the primary repeat or monitoring loop. Detection of the condition requiring the creation of a job record is shown at step 4-3, and the triggering of the off page execution of the creation subroutine of FIG. 6 is shown at step 4-4.

In the creation of a job record as outlined in the job record creation subroutine of FIG. 6, an authenticated employer client device could interact and transmit job data to the server 2 including at least any necessary information 32 for display to candidates in the offer of the related job. The capture of job data 32 from the client device is shown at step 6-1. Along with job data 32, the server could also capture job selection criteria 33 and details of any post hiring conditions 34 which must be verified or cleared in respect of the candidate following hiring for the position question. Capture of the job selection criteria 33 and post hiring condition data 34 if any is shown at steps 6-2 and 6-3. Following the capture of all the necessary information from the client device of the employer, the software can create the job record 30 corresponding to the position in the job database 11, as shown at step 6-4. Control would then be returned to the main method and routine of FIG. 4 as the embodiment demonstrates.

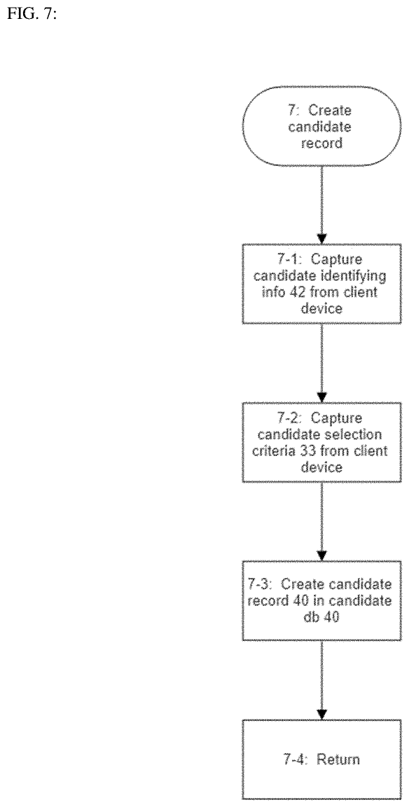

Shown next at 4-5 is another listener/decision block regarding the indication of requirement to create a candidate record 40 within the candidate database 12. Upon initiation of a communication session or interaction for the creation of a candidate record 40, or receipt of indication from a candidate client device indicating a desire to create a candidate record 40—the off page execution of the creation subroutine of FIG. 7 is shown at step 4-6.

In the candidate record creation subroutine of FIG. 7, a candidate client device could interact and transmit candidate data to the server 2 including candidate identifying information 42 which could be stored for the purpose of passing on to the employee management system of a employer where a successful manager hire was completed (Step 7-1), as well as candidate selection criteria 43, namely details of the selection qualifications possessed by the candidate which can be used for matching purposes (Step 7-2). Following the receipt of the candidate data at the server 2 from the candidate client device, the server 2 would create and store a candidate record 40, shown at 4-10.

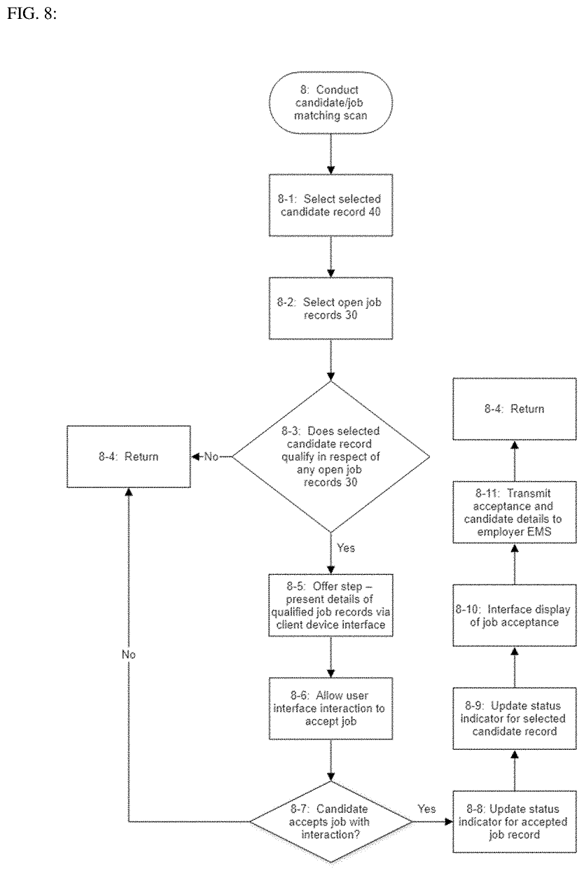

Shown next step 4-7 is a listener seeking to detect the existence of a scan condition in respect of a selected candidate record having an open candidate status indicator. As outlined elsewhere herein, a scan condition could be any preprogrammed or detected condition resulting in a desire on the part of the software component 13 to conduct a matching scan of the databases in question to ascertain whether there are any matchable open jobs for the selected candidate corresponding to the selected candidate record having the open candidate status indicator. As shown, if the existence of a scan condition is detected a matching subroutine or matching step would be conducted. Conduct of the matching subroutine, shown in FIG. 8, is shown at step 4-8. Following the completion of the matching subroutine of FIG. 8, or where no scan condition is detected, the loop of FIG. 4 continues.

Looking at the matching subroutine of FIG. 8, the matching step which is conducted on the detection of the existence of a scan condition consists of, using the hiring software component 13, first confirming or selecting the selected candidate record 40 in respect of which the matching subroutine should be executed. This is shown at step 8-1. The next step is to select any job records 30 with an open status, being open job records, from the job database (shown at 8-2). Qualifying the selected candidate record 40 against the open job records 30 consists of seeking to match the candidate selection criteria 43 of the selected candidate record 40 with the job selection criteria 33 of the corresponding open job records 30, wherein if a match exists, each matching job record 30 is a qualified job record. This first level qualification or matching step is shown at step 8-3. If there are no qualified job records, the subroutine would return control to the main method, shown at step 8-4.

If there is at least one qualified job record 30, an offer step is conducted which comprises an unattended offer of employment of any one of the jobs corresponding to the qualified job records, to the selected candidate by presenting to a user interface of a candidate client device of the candidate corresponding to the selected candidate record the details 32 of each matched job corresponding to each qualified job record. Display of the corresponding jobs being offered, to the user interface of the candidate client device of the candidate, is shown at step 8-5.

The candidate can accept one of the matched job is displayed, by engaging in a user interface interaction with the candidate client device (step 8-7). If the candidate accepts one of the matched jobs corresponding to the qualified job records by an accepting user interface interaction, job acceptance steps will be facilitated by the software component 13 by first updating the job status indicator of the corresponding job record 30 to indicate that the corresponding jobs no longer available for hiring (Step 8-8), as well as updating the candidate status indicator of the corresponding candidate record 40 to indicate the hired status of the candidate being no longer available for hiring (Step 8-9).

The software component 13 will then facilitate the provision of a user interface communication to the candidate client device of the selected candidate, confirming acceptance of the job subject to any post hiring conditions outlined in the corresponding job record 30, shown at 8-10. Finally, the server 2 will transmit the details of the corresponding candidate record 40 and the related job acceptance to the employee management system 8 of the associate employer, for completion of employee finalization and condition clearance and initiation of any other employee onboarding process, shown at 8-11. The method effectively facilitates the hiring of employees without human intervention by the employer from the completion of listing of the job to the completion of job acceptance. Return of control is then returned to the primary method of FIG. 4.

As outlined, a scan condition pursuant to which a scanning pass of the job database to ascertain any matches with a particular candidate record could be initiated as a part of a preprogrammed periodic monitoring process, could be requested to be initiated by manual interaction by the candidate subject of the candidate record, or scan conditions could also be programmed to exist to periodically conduct the matching step in respect of every active candidate record in the candidate database. There may also be certain embodiments of the method of the present invention where an employer could request the initiation of a systemwide scan condition. All such approaches are contemplated within the scope of the present invention.

The matching step will, based upon additional calculations conducted by the remainder of the method in the software, match candidates to available jobs based in part on personality trait similarities.

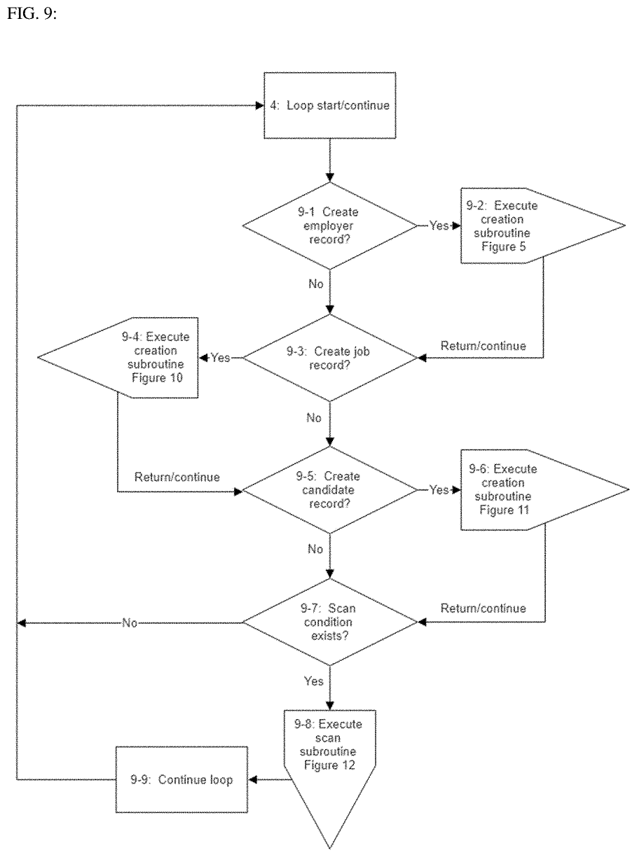

FIG. 9 is a flowchart demonstrating the steps of another embodiment of the method of the present invention, in which job candidates can be automatically matched with available employer job positions and can accept an offered job with a simple user interface interaction, including a personality matching component. The method, as executed by the hiring software component 13 in accordance with the remainder of the system of FIGS. 1 to 3, would as demonstrated be conducted in a perpetual loop fashion, although it will be understood to those skilled in the art of software design that there are many different orderings or approaches to the steps in the method as outlined which would still achieve the same objective and would not depart from the intended scope claimed herein.

The method shown in this Figure is a listener/repeat loop. A listener would determine if there was a requirement to create an employer record for a new employer in the system—likely by initiation of a communication session with an employer client device for this purpose. If a user interaction from an employer client device is detected requiring the creation of an employer record 20, an employer record creation subroutine is executed before returning to the primary repeat loop. Detection of the condition requiring creation of an employer record is shown at step 9-1, and the off page execution of the creation subroutine of FIG. 5 is shown at step 9-2. Creation of an employer record 20 would likely require the same information capture in respect of the method of FIG. 9 as it would in respect of the method of FIG. 4 and so the same demonstrated subroutine is pointed out here.

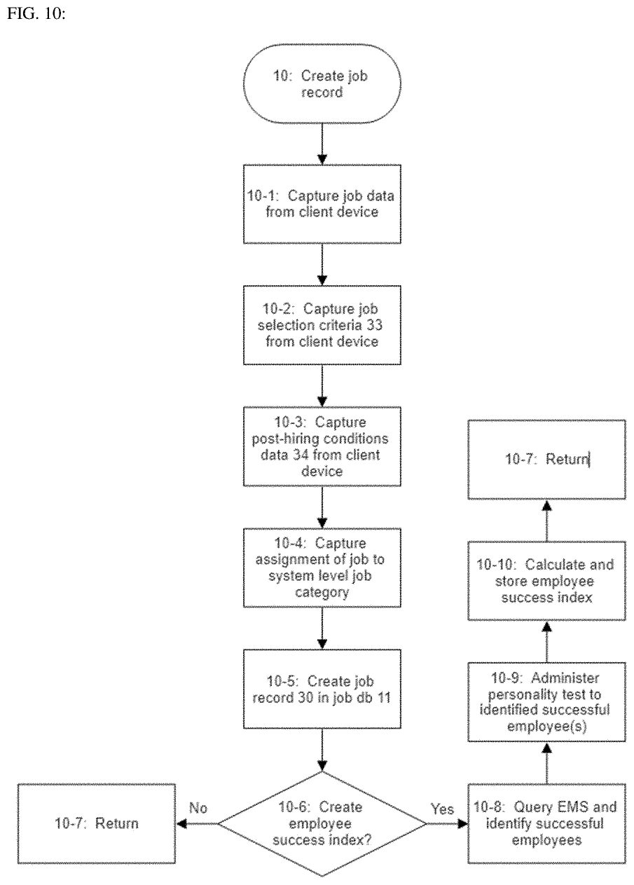

Shown next at 9-3 is another listener seeking indication of the requirement for the creation of a job record 30 in the job database 11. Upon initiation of a communication session or interaction for the creation of a job record 30, or receipt of indication from a client device indicating a desire to create a job record, a job record creation subroutine is executed before returning to the primary repeat or monitoring loop. Detection of the condition requiring the creation of a job record is shown at step 9-3, and the triggering of the off page execution of the creation subroutine of FIG. 10 is shown at step 9-4.

In the creation of a job record as outlined in the job record creation subroutine of FIG. 10, an authenticated employer client device could interact and transmit job data to the server 2 including at least any necessary information 32 for display to candidates in the offer of the related job. The capture of job data 32 from the client device is shown at step 10-1. Along with job data 32, the server could also capture job selection criteria 33 and details of any post hiring conditions 34 which must be verified or cleared in respect of the candidate following hiring for the position question. Capture of the job selection criteria 33 and post hiring condition data 34 if any is shown at steps 10-2 and 10-3.

The particular job opening subject of the job record 30 would also need to be mapped to a system level job category of the system, via the user interface provided to the employer client device. Assignment of the system level job category is shown for demonstrative purposes at step 10-4.

Creation and storage of that information to a job record 30 is shown at 10-5.

The hiring software component 13 would then verify whether or not in respect of the particular job record 30 being created and the employer in question an employee success index had yet been created for the employer and the particular system level job category in question. If there already was an employee success index in place on behalf of the employer in respect of that particular system level job category it could be linked or stored in respect of the job record 30 and the method could continue. Verifying the existence of an applicable employee success index is shown at step 10-6. If the employee success index already exists for the particular system level job category, the subroutine would return control to the main method, shown at step 10-7.

If it is necessary to establish an employee success index in respect of the particular system level job category and job record 30 being created (shown as step 10-8), the server 2 would query the employee management system 8 of the related employer and the job performance data of existing or previous employees stored thereon to identify at least one successful employee who was desire to use as indicative of a positive personality match to the job in question. If the employee success index has already been established for a particular system-level job category or the job record and employer combination, it would not necessarily be required to re-query the employee management system 8 or to regenerate that index. It will be understood that in some such instances, having already queried the employee management system 8 and identified successful employees and sent them the benchmark survey, the system will have stored the personality signatures of the successful employees as well as the types of jobs that they perform in different system-level job categories. This could be augmented or refreshed periodically including seeing how well the predictions are working and the index will improve over time. On this basis, the creation of a new job record can happen immediately based on existing indexes as they exist at any particular point in time and not require the initiation of a new passive benchmark surveys with employees of the employer. It will be understood that various approaches to the timing and calculation of the employee success index, in parallel with the creation of job records 30 or in other periodic time frames, as well as the use of data from the employer in question or from other employers whose data is perhaps anonymized and stored on the system, will all be within the scope of the intended coverage of the claims herein.

It is also likely that the employee success index for a particular employer can use success criteria from other employers to enhance the index.

As outlined elsewhere herein, the job performance data used to identify successful employees could be set on an employer basis. Length of tenure of an employee might be one basic job performance field which could be used—presuming that employees who had lasted longer in their jobs in the particular system-level job category were best suited to it and their personalities would be good to match against. It will be understood that other job performance data information in addition to length of tenure could also be used to refine or identify successful previous or existing employees in any type of job performance data used for this purpose is all contemplated within the scope of the present invention. Querying the employee management system 8 to identify previous or existing employees into jobs within the same system-level job category, being successful employees, is shown at 10-8.

The job performance data alone within the employee management system 8 could be used to establish the quantitative employee success index for each system job category. The job performance data in basic embodiments of the present invention could basically be the tenure of employment i.e. the longest term employees are the most successful in a particular culture or employer environment. However it will be understood that job performance data as a concept could extend to other performance information available within the employee management system 8 and both such approaches are intended within the scope of the present invention. For example certain embodiments of the system in accordance with the present invention might use actual performance assessment data of employees in addition to or in place of tenure as an indicator of the compatibility or level of success of an employee. Various embodiments from the simplest to the more complex data formulations based upon performance data and other tombstone data of existing employees that might be stored within the employee management system 8 are all contemplated within the scope hereof.

In other embodiments such as that shown however, job performance data would be used as an initial identifier of successful employees and the employee success index will be further informed by the administration of an objective quantitative personality assessment to each of the identified successful employees. The job performance data for the successful employees identified would include contact information by which they could be asked to participate in certain embodiments of the method. The server 2 and the software component 13 could transmit communication to each of the successful employees to initiate a communication session with them via a employee client device to conduct the standardized quantitative personality assessment. The results of the standardized quantitative personality assessment tool completed by each of the successful employees would be used by the software 13 to establish the employee success index for the system job category in question. Conduct of the quantitative personality assessment of the successful employees is shown at step 10-9.

The results of the standardized quantitative personality assessment of the successful employees is used by the software component 13 to determine are established the quantitative employee success index to be stored in respect of the particular job record 30 and the system job category. Once an employee success index is established in respect of a particular system-level job category for an employer, it does not need to immediately be recalculated for new jobs posted—the employee success index previously calculated in respect of another job record in the same system-level job category can be copied across for use. Calculation and storage of the employee success index is shown at step 10-10.

As outlined elsewhere herein, the employee success index is a quantitative measure calculated or rendered based upon the job performance data of successful employees and/or the results of standardized quantitative personality assessments thereof, yielding a set of quantitative measures against which a candidate compatibility index of a particular job candidate can be compared for the purpose of enhanced certainty and confidence in matching. The employee success index can be the result of a direct calculation applied to job performance data and/or the results of the personality assessment conducted upon successful employees, or a machine learning or artificial intelligence function could also be applied. All such approaches are contemplated within the scope of the present invention.

As shown in the figure, following the completion of the calculation of the employee success index, the job record 30 is created and stored in the job database 11, the subroutine is complete, passing back control to the main flowchart of FIG. 5.

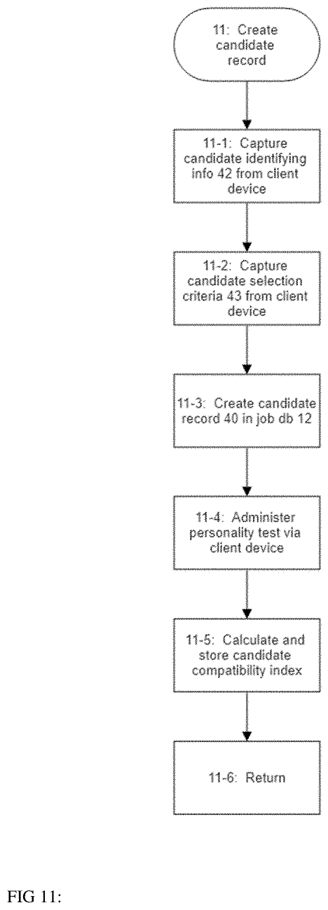

Shown next at 9-5 is another listener/decision block regarding the indication of requirement to create a candidate record 40 within the candidate database 12. Upon initiation of a communication session or interaction for the creation of a candidate record 40, or receipt of indication from a candidate client device indicating a desire to create a candidate record 40—the off page execution of the creation subroutine of FIG. 11 is shown at step 9-6.

In the candidate record creation subroutine of FIG. 11, a candidate client device could interact and transmit candidate data to the server 2 including candidate identifying information 42 which could be stored for the purpose of passing on to the employee management system of a employer where a successful hire was completed (Step 11-1), as well as candidate selection criteria 43, namely details of the selection qualifications possessed by the candidate which can be used for matching purposes (Step 11-2). Following the receipt of the candidate data at the server 2 from the candidate client device, the server 2 would create and store a candidate record 40, shown at 11-3.

In the embodiment of the method of FIG. 5 and the subroutine of FIG. 11, the software and the system will also calculate and store the candidate compatibility index value for the candidate who is the subject of the newly created candidate record. Shown at step 11-4, following the initial creation and storage of the candidate record 40, is the administration of the standardized personality test to the candidate by their client device in communication with the server. As outlined herein, the standardized personality test would be the same test administered to successful employees in the generation of employee success indexes for particular employers or available jobs.

Following the completion of the personality test at 11-4, the software would calculate the resulting candidate compatibility index value and store that to the related candidate record 40—this is shown in step 11-5. Following the calculation and storage of the candidate compatibility index value, the subroutine for creation of the candidate record will be completed and control be returned to the main method—return being shown at 11-6.

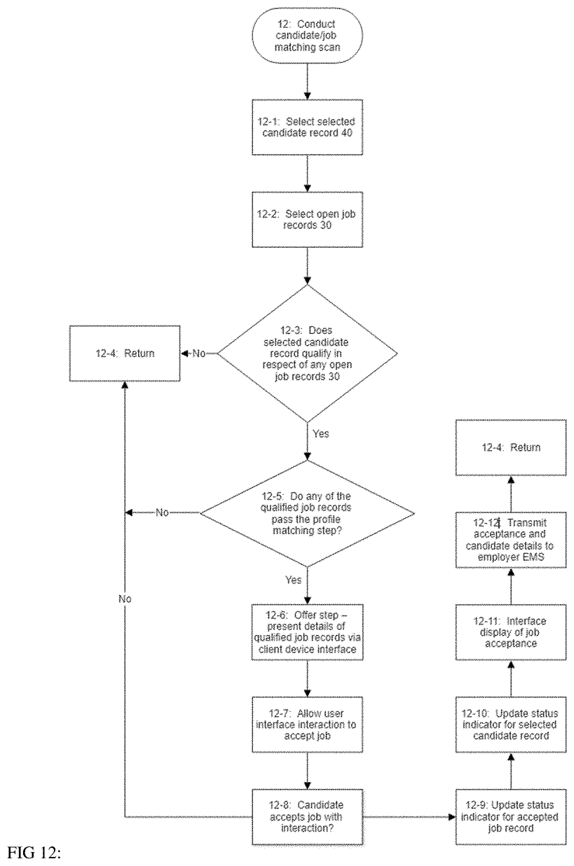

Shown next step 9-7 is a listener seeking to detect the existence of a scan condition in respect of a selected candidate record having an open candidate status indicator. As outlined elsewhere herein, a scan condition could be any preprogrammed or detected condition resulting in a desire on the part of the software component 13 to conduct a matching scan of the databases in question to ascertain whether there are any matchable open jobs for the selected candidate corresponding to the selected candidate record having the open candidate status indicator. As shown, if the existence of a scan condition is detected a matching subroutine or matching step would be conducted. Conduct of the matching subroutine, shown in FIG. 12, is shown at step 9-8. Following the completion of the matching subroutine of FIG. 12, or where no scan condition is detected, the loop of FIG. 9 continues.

Looking at the matching subroutine of FIG. 12, the matching step which is conducted on the detection of the existence of a scan condition consists of, using the hiring software component 13, first confirming or selecting the selected candidate record 40 in respect of which the matching subroutine should be executed. This is shown at step 12-1. The next step is to select any job records 30 with an open status, being open job records, from the job database (shown at 12-2). Qualifying the selected candidate record 40 against the open job records 30 consists of seeking to match the candidate selection criteria 43 of the selected candidate record 40 with the job selection criteria 33 of the corresponding open job records 30, wherein if a match exists, each matching job record 30 is a qualified job record. This first level qualification or matching step is shown at step 12-3. If there are no qualified job records, the subroutine would return control to the main method, shown at step 12-4.

If there is at least one qualified job record 30, meaning that the candidate in question at least matches the requirements or criteria of at least one job, the software that will then conduct a profile matching step in respect of any qualified job record, wherein the software will compare the candidate compatibility index stored with the selected candidate record to the employee success index of the related mapped system job category stored in association with the employer record matched to the qualified job record. The profile matching step is shown at 12-5. If the candidate compatibility index does not meet a desired configurable threshold equivalence with the employee success index the qualified job record is no longer considered a qualified job record. By seeking to determine a threshold level of personality compatibility between the selected candidate and any jobs to be offered corresponding to the qualified job records is ensured, by comparing the candidate compatibility index to the employee success index for a particular job category with the specific employer using the employee success index representing personality and character traits of successful existing and past employees, the system can within reason determine compatibility between a candidate and a position to a level of certainty that the employer's using the system would be prepared to entrust the system with automatically offering jobs on the basis of this matching profile approach.

Following the completion of the profile matching step, if there is a threshold equivalence between the candidate compatibility index of the particular candidate subject of the selected candidate record with any of the qualified job records, the system will offer those qualified job records and related positions to the candidate for acceptance in accordance with the remainder of the method. As shown at 12-6, an offer step is conducted which comprises an unattended offer of employment of any one of the jobs corresponding to the qualified job records, to the selected candidate by presenting to a user interface of a candidate client device of the candidate corresponding to the selected candidate record the details 32 of each matched job corresponding to each qualified job record. Display of the corresponding jobs being offered, to the user interface of the candidate client device of the candidate, is shown at step 12-6.

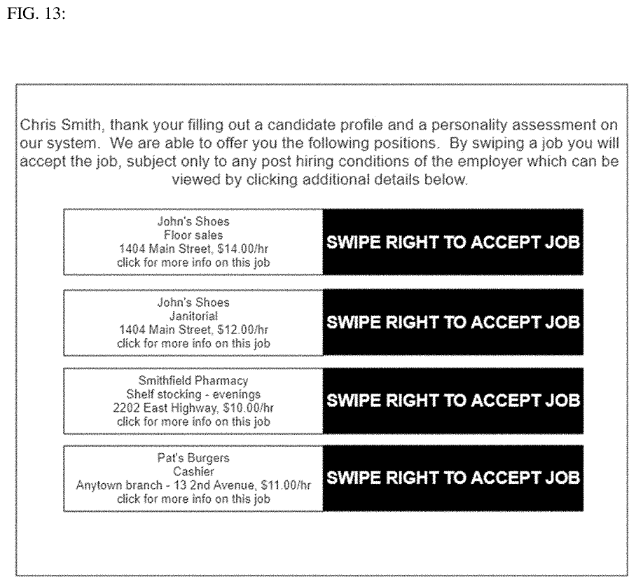

The candidate can accept one of the matched jobs displayed by engaging in a user interface interaction with the candidate client device (step 12-7). A sample mockup of a screenshot of the user interface display permitting the user interface interaction for acceptance of an offered job is shown at FIG. 13. As outlined elsewhere herein, the user interface interaction would be a simplified touch interface or other similar single or basic step interaction allowing for a very streamlined job acceptance process. In the sample mockup screen shown here, the system has determined in the profile matching step that there were four qualified job records which matched the particular candidate via a threshold equivalence determination with their candidate compatibility index. The details of those four jobs are shown in this screenshot, along with an indication that the user can accept the job by swiping. As outlined throughout, other types of user interface interactions can be contemplated also.

If the candidate accepts one of the matched jobs corresponding to the qualified job records by an accepting user interface interaction (Step 12-8), job acceptance steps will be facilitated by the software component 13 by first updating the job status indicator of the corresponding job record 30 to indicate that the corresponding jobs no longer available for hiring (Step 12-9), as well as updating the candidate status indicator of the corresponding candidate record 40 to indicate the hired status of the candidate being no longer available for hiring (Step 12-10). By updating the status indicators for accepted job records and selected candidate records representing candidates who have accepted jobs, the system of the present invention will constantly only offer up-to-date jobs that are available to candidates whose candidate records indicate that they have not yet been hired. It will also be understood that a further evolution of the embodiments of the method of the present invention could accommodate candidates holding multiple part-time jobs i.e. a candidate or employee could be asked if they would still like to receive matches—“stay on the market”—even though they have accepted a job, and the system and method of the present invention could be modified to allow for the acceptance of multiple positions.

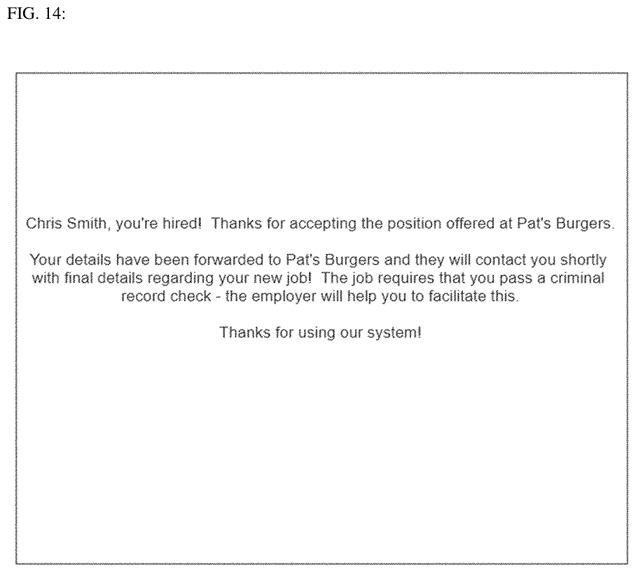

The software component 13 will then facilitate the provision of a user interface communication to the candidate client device of the selected candidate, confirming acceptance of the job subject to any post hiring conditions outlined in the corresponding job record 30, shown at 12-11. A sample screen mockup of such a display is shown in FIG. 14. As shown in this Figure, the system could provide a brief notification of the acceptance of the position, outlined any post hiring conditions that need to be satisfied etc.

Finally, the server 2 will transmit the details of the corresponding candidate record 40 and the related job acceptance to the employee management system 8 of the associate employer, for completion of employee finalization and condition clearance and initiation of any other employee onboarding process, shown at 12-12. The method effectively facilitates the hiring of employees without human intervention by the employer from the completion of listing of the job to the completion of job acceptance. Return of control is then returned to the primary method of FIG. 9. In certain embodiments of the method of the present invention, rather than communicating the details of the accepted position and hire directly to a network connected employee management system 8, in more basic embodiments of the method without departing from the intended scope hereof, there could be a transmitted system output such as an email notification or the like to the employer that a hire has occurred, with the details thereof, and the employee management system 8 could be manually updated by the employer.

As outlined elsewhere herein, the candidate compatibility index is a quantitative measure calculated or rendered based upon the results of the standardized quantitative personality assessment administered to the candidate in the creation of the record 40. The candidate compatibility index is a set of quantitative measures against which the employee success index of a particular job record can be compared for the purpose of enhanced certainty and confidence in matching. The candidate compatibility index can be the result of a direct calculation applied to job performance data and/or the results of the personality assessment conducted upon successful employees, or a machine learning or artificial intelligence function could also be applied. As outlined elsewhere herein, additional datasets can also be used, including credit score information, genetic markers or the like and all such approaches are contemplated within the scope of the present invention.

As will be understood throughout, the employee success index and the candidate compatibility index are contemplated to each be determined by the system of the present invention as a quantitative measure which quantitatively represents the personality traits of the successful employees of the employer in question or of the candidate themselves, such that they can quantitatively be compared for the purpose of determining equivalence and matching of the personality of a particular candidate with a particular job of an employer. Any number of different types of quantitative measures will be understood to those skilled in the art, including those that could be rendered using artificial intelligence assisted algorithms and other machine learning technologies based upon the datasets available, and any type of employer success index or candidate compatibility index measurements can be developed for use in accordance with the matching method of the present invention to allow for a profile matching step to be undertaken to match the personalities of candidates with successful employees in jobs of an employer will be understood to be within the scope of the present invention.

It will be apparent to those of skill in the art that by routine modification the present invention can be optimized for use in a wide range of conditions and application. It will also be obvious to those of skill in the art that there are various ways and designs with which to produce the apparatus and methods of the present invention. The illustrated embodiments are therefore not intended to limit the scope of the invention, but to provide examples of the apparatus and method to enable those of skill in the art to appreciate the inventive concept.

Those skilled in the art will recognize that many more modifications besides those already described are possible without departing from the inventive concepts herein. The inventive subject matter, therefore, is not to be restricted except in the scope of the appended claims. Moreover, in interpreting both the specification and the claims, all terms should be interpreted in the broadest possible manner consistent with the context. The terms “comprises” and “comprising” should be interpreted as referring to elements, components, or steps in a non-exclusive manner, indicating that the referenced elements, components, or steps may be present, or utilized, or combined with other elements, components, or steps not expressly referenced.

1. A system to be used in the computer-implemented hiring of employees whereby employers can automate the hiring of compatible candidates for available jobs, said system comprising:
a. a server having:
i. a processor and memory;
ii. a network interface capable of communication with client devices of employers, existing and past employees and candidates;
iii. a standardized list of system job categories stored in the memory against which available jobs can be mapped;
iv. an employer database comprising an employer record for each employer using the method, each employer record including:
1. employer identification information of the employer;
2. employee management system information of the employer containing job performance data of existing and past employees; and
3. stored data corresponding to a quantitative employee success index for each applicable system job category representing personality characteristics of successful existing or past employees of the employer in jobs corresponding to the system job category;
v. a job database comprising a job record corresponding to each job to be filled using the method, each job record comprising:
1. a connection to an employer record in the employer database;
2. at least one job selection criteria for the job, being selection criteria which successful candidates for the corresponding job must possess in order to be qualified for selection by the employer for the corresponding job;
3. indication of any post-hiring conditions which will be required to be verified in respect of a successful candidate following acceptance of an automatically offered job in accordance with the method; and
4. a job status indicator indicating the open or completed status of hiring for the job;
vi. a candidate database comprising a candidate record corresponding to each candidate and which can be used for matching and hiring in accordance with the method, each candidate record comprising:
1. candidate selection criteria, representing selection qualifications possessed by the candidate; and
2. a candidate status indicator indicating the available or hired status for the candidate in accordance with the method;
b. a hiring software component operable on the server and capable of executing the steps of the method;
wherein the system enables the method by:
a. as required, creating employer records in the employer database for each employer desiring to hire using the method by:
i. capturing employer identification information of the employer including employee management system information of the employer containing job performance data of existing and past employees of the employer;
ii. querying the job performance data within the employee management system information of the employer to identify a plurality of successful existing or past employees corresponding to each applicable system job category, being successful employees;
iii. determining a quantitative employee success index value for each applicable system job category using the job performance data of the successful employees; and
iv. creating and storing a corresponding employer record in the employer database;
b. as required, creating job records in the job database for each job of an employer for whom a candidate is desired to be hired by:
i. capturing job data from an employer client device in communication with the server including at least:
1. job identifying information;
2. employer identifying information by which the job record can be associated with a linked employer and linked employer record;
3. any job selection criteria of the job; and
ii. creating a job record using the captured job data including setting the job status indicator as open to indicate the associated job is available for hiring;
c. as required, creating candidate records in the candidate database for each new job candidate seeking employment through the method by:
i. capturing candidate data from a candidate client device in communication with the server including at least candidate identifying information and candidate selection criteria of the candidate; and
ii. creating a candidate record using the captured candidate data including setting the candidate status indicator to indicate the available status of the associated candidate for hiring;
d. in a matching step on detection of the existence of a scan condition in respect of a selected candidate record having an available candidate status indicator:
i. selecting any job records with an open status, being open job records, from the job database;
ii. qualifying the selected candidate record with the open job records by seeking to match the candidate selection criteria of the selected candidate record with the job selection criteria of each open job record, wherein if a match exists each matching job record is a qualified job record;
e. if there is at least one qualified job record, facilitating an offer step being an unattended offer of employment of any one of the jobs corresponding to the qualified job records to the selected candidate by:
i. presenting to a user interface of a candidate client device the details of the matched jobs corresponding to each qualified job record;
ii. permitting the candidate to accept one of the matched jobs by a user interface interaction via the interface of the candidate client device;
iii. if the candidate accepts a matched job by a user interface interaction:
1. updating the job status indicator of the corresponding job record to indicate that the job is no longer available for hiring;
2. based upon data having been received from the candidate optionally updating the candidate status indicator of the corresponding candidate record to indicate that the selected candidate is no longer seeking employment;
3. providing a user interface communication to the selected candidate confirming acceptance of the job subject to the post-hiring conditions outlined in the corresponding job record; and
4. transmitting the details of the corresponding candidate record and matched job acceptance to the associated employer for completion of the employee finalization and onboarding process including clearance of any post-hiring conditions outlined in the job record;
wherein the hiring of employees in accordance with the method takes place without user interaction or additional intervention on the part of the employer during hiring; and
wherein the acceptance of a matched job by a candidate in accordance with the method is subject only to post-hiring validation of the prescribed post-hiring conditions by the employer and in all respects constitutes the formal receipt and acceptance of an offer of employment.

2. The system of claim 1 wherein the employee management system information of the employer comprises a data file containing job performance data of existing and past employees, loaded and stored in an employer record.

3. The system of claim 1 wherein the network interface of the server is also capable of communicating with network connected employee management systems of employers, and the employee management system information stored in an employer record is the necessary authentication credentials to permit direct communication and queries between the server and the employee management system, wherein the server can directly query live data on the employee management system of an employer where required.

4. The system of claim 1 wherein the candidate selection criteria stored in a candidate record are selected from the group of:
a. desired location of employment;
b. physical attributes of the candidate for consideration in hiring for a manual labour job; or
c. certifications or licenses held by the candidate.

5. The system of claim 1 wherein the at least one job selection criteria are selected from the group of:
a. age of the candidate;
b. employer location of the job;
c. physical requirements of a successful candidate for hiring in a manual labour job; or
d. certification or licensing requirements of a successful candidate.

6. The system of claim 1 wherein the post-hiring conditions required to be verified in respect of the successful candidate are selected from the list of:
a. successful completion of a criminal record or background check of the successful candidate; or
b. successful verification of certification or licensing requirements of the successful candidate.

7. The system of claim 1 wherein the management system information associated with an employer record includes job performance data and a job category indicator for mapping the corresponding employee and their job against the list of system job categories for each existing or past employee.

8. The system of claim 7 wherein the determination of the quantitative employee success index for each system job category further comprises administering a standardized quantitative personality assessment to each of the selected successful employees by using the server at the software to:
a. administer a standardized quantitative personality assessment to each of the successful employees via the user interface of their client devices, and capturing the results of same at the server; and
b. using the results of the standardized quantitative personality assessment of the successful employees in the determination of the quantitative employee success index value for each applicable system job category.

9. The system of claim 8 wherein the quantitative employee success index for a system job category is determined based upon a direct calculation using the job performance data of the successful employees along with the corresponding captured quantitative personality assessment results.

10. The system of claim 8 wherein the quantitative employee success index for a system job category is determined using a machine learning function applied to at least the job performance data from the employee management system of the successful employees along with the corresponding captured quantitative personality assessment results to yield a quantitative employee success index rendered based upon the relations in this data.

11. The system of claim 8 further comprising the creation and storage of a quantitative candidate compatibility index representing personality characteristics of a candidate in each candidate record by, during the creation of a candidate record:
a. using the system in communication with the candidate client device to administer the standardized quantitative personality assessment to the candidate and capturing the results of same at the server; and
b. establishing a quantitative candidate compatibility index of the candidate based on the received results of the personality assessment and storing same to the candidate record.

12. The system of claim 11 wherein the quantitative candidate compatibility index is established based upon a direct calculation on the results of the personality assessment received.

13. The system of claim 11 wherein the quantitative candidate compatibility index is established using a machine learning function relying upon the personality assessment results received and stored in the candidate record along with external datasets corresponding to the candidate.

14. The system of claim 11 wherein the matching step further comprises conducting a profile matching step in respect of any qualified job record following the determination of the existence of any qualified job records whereby threshold level of personality compatibility between the selected candidate and any jobs to be offered corresponding to the qualified job records is insured, by comparing the candidate compatibility index stored with the selected candidate record to the employee success index of the related mapped system job category stored in association with the employer record matched to the qualified job record;
whereby if said candidate compatibility index does not meet a desired configurable threshold equivalence with the employee success index the qualified job record is no longer considered a qualified job record.

15. The system of claim 1 wherein the network is the Internet.

16. The system of claim 15 wherein the server is a Web server, and the client devices are mobile or remote devices operatively connected to the network and capable of communicating with the server via a web interface served therefrom.
